(19) United States
(12) Patent Application Publication
(10) Pub. No.: US 2018/0323050 A1
(43) Pub. Date: Nov. 8, 2018

(54) ION INTEGRATING AND COOLING CELL FOR MASS SPECTROMETER

(71) Applicant: Thermo Finnigan LLC, San Jose, CA (US)

(72) Inventors: Johnathan Wayne SMITH, Jonesborough, TN (US); John E. P. SYKA, Charlottesville, VA (US)

(73) Assignee: Thermo Finnigan LLC

(21) Appl. No.: 15/588,158

(22) Filed: May 5, 2017

(51) Int. Cl. H01J 49/04; H01J 49/00; H01J 49/42

(52) U.S. Cl. CPC H01J 49/0468; H01J 49/4215; H01J 49/4225; H01J 49/0031

(57) ABSTRACT

A method for operating a mass spectrometer comprises: generating a stream of ions by an ion source; directing the stream of ions into a first one of a pair of ion storage locations and trapping a first portion of the ions therein; directing a packet of ions from the other one of the pair of ion storage locations into an ion cooling cell that damps the kinetic energy of the ions comprising the packet of ions; directing the packet of ions to a mass analyzer of the mass spectrometer for mass analysis thereby; directing the first portion of ions from the first one of the pair of ion storage locations into the ion cooling cell; and directing the first portion of ions to the mass analyzer for mass analysis thereby.

### CROSS REFERENCE TO RELATED APPLICATIONS

This application is related to the following commonly-owned United States patents and co-pending applications: U.S. Pat. No. 8,389,929 filed Mar. 2, 2010; U.S. Pat. No. 8,704,163 filed Mar. 4, 2013 and U.S. Pat. No. 8,841,610 filed Apr. 18, 2014, each of said patents entitled “Quadrupole Mass Spectrometer With Enhanced Sensitivity And Mass Resolving Power” and in the names of inventors Schoen et al.; U.S. patent application Ser. No. 14/263,947 filed Apr. 28, 2014 entitled “Method for Determining a Spectrum from Time-Varying Data” in the names of inventors Smith et. al.; U.S. Pat. No. 9,355,828 filed Dec. 4, 2014; U.S. Pat. No. 9,524,855 filed Dec. 11, 2014; U.S. Pat. No. 9,490,115 filed Dec. 18, 2014; and U.S. patent application Ser. No. 14/575,802 filed Dec. 18, 2014 entitled “Tuning a Mass Spectrometer Using Optimization” in the name of inventor Smith. The disclosures of all of the above-listed United States patents and United States patent applications are hereby incorporated by reference in their entirety.

### FIELD OF THE INVENTION

This invention relates generally to mass spectrometers, and more particularly, to mass spectrometers that employ a quadrupole mass filter as a mass analyzer.

### BACKGROUND OF THE INVENTION

Quadrupole mass filters have been widely used for decades for routine mass spectrometric analysis of a variety of substances, including small molecules such as pharmaceutical agents and their metabolites, as well as large biomolecules such as peptides and proteins. FIG. 1 depicts the components of a conventional triple-quadrupole mass spectrometer system 10 comprising a mass analyzer that comprises a quadrupole mass filter 24. An ion source 12, which may take the form of an electrospray ion source, generates ions from an analyte material, for example the eluate from a liquid chromatograph (not depicted). The ions are transported from ion source chamber 14, which for an electrospray source will typically be held at or near atmospheric pressure, through several intermediate chambers 16, 18 and 21 of successively lower pressure, to a high-vacuum chamber 23 within which the quadrupole mass filter apparatus 24 is disposed. Efficient transport of ions from ion source 12 to the quadrupole mass filter 24 is facilitated by a number of ion optic components, including quadrupole RF ion guides 25 and 29, octopole RF ion guide 32, skimmer 26, and electrostatic lenses 27 and 34. Ions may be transported between ion source chamber 14 and the first intermediate chamber 16 through an ion transfer tube 35 that is heated to evaporate residual solvent and break up solvent-analyte clusters. Intermediate chambers 16, 18 and 21 and high-vacuum chamber 23 are evacuated by a suitable arrangement of pumps to maintain the pressures therein at the desired values.

As will be discussed below in further detail, the quadrupole mass filter 24 is provided with electrodes 36 and 38 (which may take the form of conventional plate lenses) positioned axially outward from the quadrupole electrodes to assist in the generation of an electrical potential gradient to effect controlled introduction of ions into the interior volume of the quadrupole mass filter 24. The mass analyzer additionally comprises an ion detector 48 that generates a signal representative of the abundance of ions that pass completely through the quadrupole mass filter 24.

During mass analysis, a filtering DC component is added to the RF voltage applied to the electrodes of the quadrupole mass filter apparatus 24 by voltage supply system 15, in a manner known in the art. Ions enter an inlet end of the quadrupole mass filter 24 as a continuous or quasi-continuous ion beam. Ions in the selected range of m/z values (selection being achieved by choosing appropriate values of the magnitudes of the applied DC and RF voltages) maintain stable trajectories within the interior of the quadrupole mass filter 24 and leave the mass filter apparatus 24 via an outlet end thereof, and are thereafter delivered to detector 48, which generates a signal representative of the abundance of transmitted ions. Ions having m/z values outside of the selected range develop unstable trajectories within the quadrupole mass filter and hence do not arrive at the detector 48. During operation, DC offsets applied to the quadrupole rods of quadrupole mass filter 24 and to electrodes 36 and 38 by voltage supply system 15 are set to enable the transport of the selected ions through the quadrupole mass filter 24 to the detector 48.

FIG. 1 further depicts that, according to the conventional triple-quadrupole configuration, the quadrupole mass filter apparatus 24 (which is employed as a mass analyzer) is placed downstream of a first quadrupole mass filter (QMF) 43 and a collision cell 44. The collision cell 44 or possibly a separate “cooling” cell may also serve the function of ion kinetic cooling through the conversion of ion kinetic energy into thermal energy of neutral gas molecules within the cell. The collision cell 44 may also be constructed as a conventional multipole structure to which an RF voltage is applied to provide radial confinement. The interior of the collision cell 44 is provided with a suitable collision gas through gas inlet tube 45, and the kinetic energies of ions entering the collision cell 44 may be regulated by adjusting DC offset voltages applied to the upstream ion guides 25, 29, the first quadrupole mass filter 43, the collision cell 44 and the ion lens 46.

During operation of the conventional triple quadrupole mass spectrometer system 10, ions are selectively transmitted by the first quadrupole mass filter 43 and fragmented in the collision cell 44 and the resultant product ions are selectively transmitted by the quadrupole mass filter mass analyzer apparatus 24 to the detector 48. Samples may be analyzed using standard techniques employed in triple quadrupole mass spectrometry, such as precursor ion scanning, product ion scanning, single- or multiple reaction monitoring, and neutral loss monitoring, by applying (either in a fixed or temporally scanned manner) appropriately tuned RF and DC voltages to the first quadrupole mass filter 43 and the quadrupole mass filter mass analyzer apparatus 24.

The operation of the various components of the mass spectrometer system 10 is directed by a control and data system 13, which typically consists of a combination of general-purpose and specialized processors, application-specific circuitry, and software and firmware instructions. The control and data system 13 also provides data acquisition and post-acquisition data processing services.

The motion of ions within an ideal 2D quadrupole is modeled by the Mathieu equation. Solutions to the Mathieu equation are generally described in terms of the dimensionless Mathieu parameters, “aᵤ” and “qᵤ” (where u represents an x, y or z spatial dimension), which are defined as:

$${a}_{u} = \frac{{K}_{a} eU}{{mr}_{0}^{2} {Ω}^{2}} ; {q}_{u} = \frac{{K}_{q} eV}{{mr}_{0}^{2} {Ω}^{2}}$$

in which e is the charge on an electron, U is an amplitude of an applied DC voltage, V is an amplitude (zero-to-peak) of an applied RF voltage, m is the mass of the ion, r₀ is a characteristic dimension of a device, Kₐ and Kᵤ are device-field geometry dependent constants and Ω is the applied RF frequency in radians/second where Ω=27πf where f is the frequency of the RF voltage. General solutions of the Mathieu equation can be classified as either bounded and non-bounded and whether both general solution are bounded depends only upon these two parameters. Bounded particular solutions correspond to trajectories in the respective dimension that never exceed maximum absolute displacements from the origin, and these maximum displacements depend on the ion's initial conditions (displacement and velocity in the respective dimension). Typically, bounded solutions in both the x and y dimensions are equated with trajectories allow an ion to transit axially (z dimension) through the quadrupole or to remain confined in the device whereas non-bounded solutions are equated with trajectories that grow so as to cause the ion to hit the rod electrodes or otherwise be ejected from the device in the transverse dimensions (x and y dimensions). The specific trajectory for a particular ion depends on a set of initial conditions—the ion's position and velocity as it enters the quadrupole and the RF phase of the quadrupole at that instant.

As known to those skilled in the art and as described above, the equations of motion in the transverse dimensions, x and y, of a 2D quadrupole, in the ideal case of static field RF and DC field intensities and a perfect quadrupole field, may be converted into Mathieu equations. Since the parameters for the x-dimension and y-dimension Mathieu equations are related as aₓ=−a_{y} and qₓ=−q_{y} and since the inversion in sign between qₓ and q_{y} is simply a phase shift and does not alter the stability or boundedness of the solutions, a single plot in the space of aₓ and qₓ may used to show which combinations of aₓ and qₓ correspond to bounded/stable motion in the x dimension, the y dimension and both the x and y dimensions motion. As shown in FIG. 2 (the axis labels a and q correspond to aₓ and qₓ) the plane of (qₓ, aₓ) values can be partitioned into contiguous regions corresponding to bounded solutions and unbounded solutions in each dimension of motion. Such a depiction of the bounded and unbounded motion regions in a q-a plane is called a stability diagram. Additionally, dashed and dashed-dotted lines in FIG. 2 represent lines of iso-βₓ and iso-β_{y}, respectively, where the Mathieu parameters βₓ and β_{y} are the characteristic frequencies of ion motion in the subscripted dimensions in the normalized time domain of the standard form of the Mathieu equation and which are related to ion oscillation characteristic frequencies, ωₓ and ω_{y}, in the x- and y-directions as βₓf/2 and β_{y} f/2 respectively and which depend wholly on aₓ and qₓ.

During conventional operation of a quadrupole apparatus as a quadrupole mass filter for mass analysis, the instrument may be “scanned” by increasing both U and V amplitude monotonically and in proportion to one another so as to bring different portions of the full range of m/z values into the stability region at successive time intervals, in a progression from low m/z to high m/z. During conventional mass scanning operation, the voltages U and V are ramped approximately in accordance with a scan line (e.g., scan line 1 in FIG. 2) that passes very close to the apex of the stability region, thus permitting only a very narrow pass band that moves through the m/z range with time. Scan line 1, which passes through the stability region boundary points 2 and 8 resembles a conventional scan line in that only a very narrow range of mass-to-charge values are transmitted at any particular time.

The inventors of U.S. Pat. No. 8,389,929, which is assigned to the assignee of the present invention and which is incorporated by reference herein in its entirety, recognized that, by recording where the ions strike a position-sensitive detector as a function of the applied RF and DC fields and subsequently applying a mathematical deconvolution procedure to the recorded data, it is possible to increase the sensitivity of a quadrupole mass filter while maintaining spectral resolution. When the arrival times and positions are binned, the data can be thought of as a series of ion images. Each observed ion image is essentially the superposition of component images, one for each distinct m/z value exiting the quadrupole at a given time instant.

According to the teachings of U.S. Pat. No. 8,389,929, each individual component image can be extracted from a sequence of observed ion images by mathematical deconvolution or decomposition processes, as further discussed in the patent. The mass-to-charge ratio and abundance of each species necessarily follow directly from the deconvolution or decomposition. In contrast to the conventional mode of scanning, as represented by scan line 1 in FIG. 2, the scanning methods taught in the aforementioned U.S. Pat. No. 8,389,929 teach modes of scanning that employ scan lines, such as the scan line 3 (FIG. 2), that pass through a wider portion of the stability region and through the boundary points 6 and 4. The aforementioned U.S. Pat. No. 8,389,929 teaches, inter alia, a mass spectrometer instrument having both high mass resolving power and high sensitivity, the mass spectrometer instrument including: a multipole configured to pass an abundance of one or more ion species within stability boundaries defined by applied RF and DC fields; a detector configured to record the spatial and temporal properties of the abundance of ions at a cross-sectional area of the multipole; and a processing means. High mass resolving power may be achieved under a wide variety of operating conditions, a property not usually associated with quadrupole mass spectrometers.

The inventors of the present application have recognized that mass spectral results obtained in accordance with the methods taught in the aforementioned U.S. Pat. No. 8,389,929 may be sensitive to temporal ion flux variations as may be caused by electrospray sputter, chromatographic skew, or any other physical event that may alter the flux of ions arriving at the quadrupole on the same time scale as that of the plurality of ion images whose information is used to mathematically generate a mass spectral peak. The inventors of the present application have further recognized that the adverse effects of ion flux variability may be compensated by integrating the variable ion flux over discrete time intervals so as to average out the flux variations prior to transmitting the ions to a quadrupole mass filter that is operated in accordance with the methods taught in the aforementioned patent. Additionally, the inventors of the present application have recognized that it is possible to optimize mass spectral results obtained in accordance with the methods taught in the aforementioned patent by damping the kinetic energy of ions entering the quadrupole as much as possible. Accordingly, there is a need for an apparatus or a combination of apparatuses that can both integrate ion flux variation as well as damp ionic thermal kinetic energy. The present invention addresses these needs.

### SUMMARY OF THE INVENTION

To address the above-noted needs, the inventors here disclose apparatuses, methods and systems for both averaging fluctuations in an ion beam and for damping ions' thermal energy prior to introduction of the ions into a mass analyzer. The inventors further disclose apparatuses methods and systems for damping the thermal energy prior to the introduction of the ions into a quadrupole mass filter mass analyzer that employs a detector that generates images of ion spatial distributions at the exit of the quadrupole mass filter. In accordance with some embodiments, a triple quadrupole mass spectrometer is modified by including either a single apparatus or a system of apparatuses upstream from a quadrupole mass filter, wherein the apparatus or system is functional to continually integrate the flux of and kinetically cool the energy of a beam of ions by collecting packets of ions in an ion trap over discreet time intervals and gradually introducing ions of each ion packet to the quadrupole mass filter. An inert cooling gas is provided within the ion trap within which the ion packets are collected so as to enable accumulation and trapping of ions and reduce their kinetic energy and kinetic energy spread prior to the introduction of the ions into the quadrupole mass filter. The ions that are released from the ion trap may be delivered to the quadrupole mass filter in a progressive m/z selective manner and in coordination with the m/z scanning of the quadrupole mass filter such that the quadrupole mass filter is set to pass (transmit) each particular m/z range of ions just at the same time that those ions arrive at the quadrupole mass filter and such that ions pass into and through the quadrupole mass filter at a same constant velocity, irrespective of their m/z ratio. In some specific embodiments, the flux-varying ion beam is directed into one or the other of two ion storage locations while ions contained within the other one of the two ion storage locations are being emptied out into a further cooling section before prior to being released to the quadrupole mass filter. The switching between these two storage pools can be achieved via switchable potential barriers or an ion beam switch that is integrated into an ion guide. The method to scan ions out into the further cooling region include generating a DC voltage potential gradient so as to concentrate a batch or packet of ions at the end of the storage location while using an RF pseudo-potential barrier to prevent them from transmitting through. The barrier may be slowly lowered, as has been demonstrated previously, such that ions are released from the storage location sequentially from high to low mass-to-charge ratio (m/z).

In accordance with an aspect of the present teachings, a method for operating a mass spectrometer is disclosed, wherein the method comprises: generating a stream of ions by an ion source; directing the stream of ions into a first one of a pair of ion storage locations and trapping a first portion of the ions therein; directing a packet of ions from the other one of the pair of ion storage locations into an ion cooling cell that damps the kinetic energy of the ions comprising the packet of ions; directing the packet of ions to a mass analyzer of the mass spectrometer for mass analysis thereby; directing the first portion of ions from the first one of the pair of ion storage locations into the ion cooling cell; and directing the first portion of ions to the mass analyzer for m/z analysis thereby.

### BRIEF DESCRIPTION OF THE DRAWINGS

The above noted and various other aspects of the present invention will become apparent from the following description which is given by way of non-limiting example only and with reference to the accompanying drawings, not drawn to scale, in which:

FIG. 1 is a schematic depiction of a conventional triple-quadrupole mass spectrometer system utilizing a quadrupole mass filter mass analyzer;

FIG. 2 is a graphical depiction of a stability region for a quadrupole mass filter in terms of the Mathieu parameters q and a;

FIG. 3 is a schematic depiction of a portion of triple-quadrupole mass spectrometer system the employs, in accordance with some embodiments in accordance with the present teachings, an additional ion cooling cell disposed upstream of a quadrupole mass analyzer that employs an imaging detector;

FIG. 4 is a schematic depiction of a portion of triple-quadrupole mass spectrometer system the employs, in accordance with some embodiments in accordance with the present teachings, an additional ion integration (accumulation) device that includes a multipole ion trap and an ion cooling cell, the additional integral device disposed upstream of a quadrupole mass analyzer that employs an imaging detector;

FIG. 5 is a schematic depiction of a portion of a triple-quadrupole mass spectrometer system that employs, in accordance with some embodiments in accordance with the present teachings, a system comprising a pair of additional integral devices and a pair of switchable branched ion guides disposed upstream of a quadrupole mass analyzer that employs an imaging detector, wherein each ion integration (accumulation) device includes a multipole ion trap and an ion cooling cell;

FIG. 6A is a schematic depiction of a first operational configuration of the system of FIG. 5;

FIG. 6B is a schematic depiction of a first operational configuration of the system of FIG. 5;

FIG. 7 is perspective depiction and pair of cross sectional depictions of a known switchable branched ion guide as may be employed in various embodiments of mass spectrometer systems in accordance with the present teachings;

FIG. 8A is a schematic depiction of a portion of triple-quadrupole mass spectrometer system that employs, in accordance with some embodiments in accordance with the present teachings, a system comprising switchable branched ion trap apparatus that includes a switchable ion-path-branching section, a pair of ion storage sections and a switchable ion-path converging section, the system disposed upstream of a quadrupole mass analyzer that employs an imaging detector;

FIG. 8B is a schematic depiction of a portion of another triple-quadrupole mass spectrometer system that employs, in accordance with some embodiments in accordance with the present teachings, a system comprising a switchable branched ion trapping and cooling apparatus that includes a switchable ion-path-branching section, a pair of ion storage sections and, a switchable ion-path converging section and an ion cooling section, the system disposed upstream of a quadrupole mass analyzer that employs an imaging detector;

FIG. 9A is a detailed schematic depiction of an embodiment, in accordance with the present teachings, of a switchable branched ion trap apparatus as depicted in FIG. 8A and FIG. 8B;

FIG. 9B is a pair of schematic cross-sectional views through the switchable branched ion trap apparatus of FIG. 9A;

FIG. 10A is a schematic depiction of a first operational configuration of the switchable branched ion trap apparatus of FIG. 9A;

FIG. 10B is a schematic depiction of a second operational configuration of the switchable branched ion trap apparatus of FIG. 9A; and

FIG. 11 is a detailed schematic depiction of a second embodiment, in accordance with the present teachings, of a switchable branched ion trapping and cooling apparatus as may be employed in the system illustrated in FIG. 8B.

### DETAILED DESCRIPTION

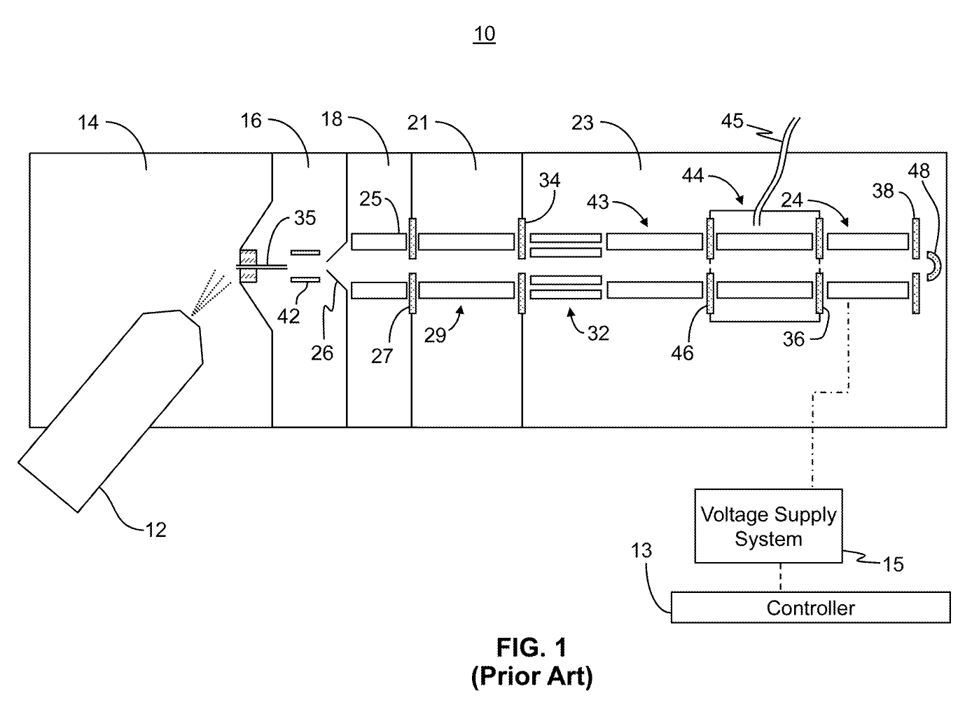

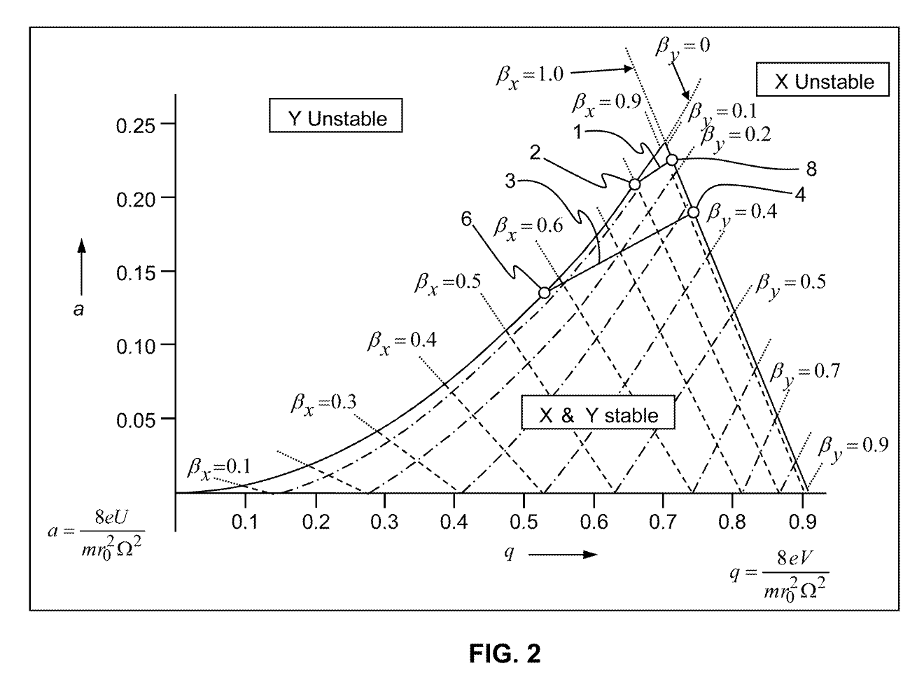

The following description is presented to enable any person skilled in the art to make and use the invention, and is provided in the context of a particular application and its requirements. Various modifications to the described embodiments will be readily apparent to those skilled in the art and the generic principles herein may be applied to other embodiments. Thus, the present invention is not intended to be limited to the embodiments and examples shown but is to be accorded the widest possible scope in accordance with the features and principles shown and described. It should be noted that, in the following discussion, references to a Direct Current (DC) voltage applied to one or more electrodes are not intended to imply that an electrical current is necessarily caused to flow through the electrode but instead refer to application of a non-oscillatory voltage profile (as contrasted with the oscillatory voltage profile of a Radio Frequency or RF voltage) that may be, but is not necessarily, static. The particular features and advantages of the invention will become more apparent with reference to the appended FIGS. 1-5, 6A, 6B, 7, 8A, 8B, 9A, 9B, 10A, 10B and 11, taken in conjunction with the following description.

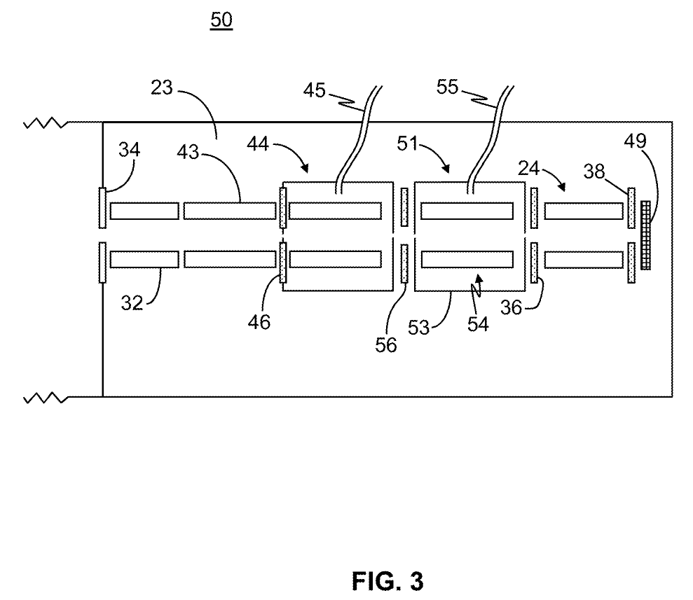

FIG. 3 illustrates a portion of a triple quadrupole mass spectrometer system 50 that has been modified from a conventional configuration (e.g., the configuration illustrated as system 10 in FIG. 1) by incorporation of an additional “cooling cell” 51 which is provided so as to damp and reduce the spread of the kinetic energy of ions prior to the introduction of the ions into a quadrupole mass filter 24. The system 50 is further modified, relative to the conventional system 10, by replacement of the conventional current detector 48 by an imaging detector 49. It should be noted that like reference numbers in FIG. 1 and FIG. 3 denote like components and that additional components of the system that are disposed to the left of the electrostatic lens 34 have been omitted for clarity. Such omitted components may be but are not necessarily configured identically to the configuration illustrated in FIG. 1.

The cooling cell 51 includes a multipole 54 (which, preferably, is a quadrupole) which is contained within an enclosure 53 and which is operated in RF-only mode. A suitable inert gas which is provided into the enclosure 53 through gas inlet tube 55 provides neutral molecules that may absorb the kinetic energy of ions upon colliding with the ions. An electrical potential difference between ion lens 56 and ion lens 36, disposed at opposite ends of the cooling cell, propels the ions through the cooling cell. Alternatively or additionally, the cooling cell may employ supplementary or segmented electrodes or a modified rod configuration, in accordance with one of many known designs, so as to generate an axial or drag field along the length of the cell to gently drive the ions through the length of the cooling cell. The kinetically cooled ions exit the cooling cell and are introduced into the quadrupole mass filter 24 by means of a variable DC electrical potential difference applied between the quadrupole rods and either the cooling cell rods or the ion lens 36 (or both). The variable DC electrical potential difference or differences, including a DC potential difference between the quadrupole rods and ion lens 38, may be controlled such that ions pass into and through the quadrupole at a constant velocity as the mass-to-charge ratio of the ions changes during m/z scanning. The reduction of the ions' kinetic energy provided by the cooling cell 51 limits the axial velocity distribution of the ions and reduces the size of the spread of the ion cloud around the central axis of the quadrupole. This kinetic cooling thereby causes better definition or restriction of the initial states of the ions as they enter the quadrupole mass filter 24.

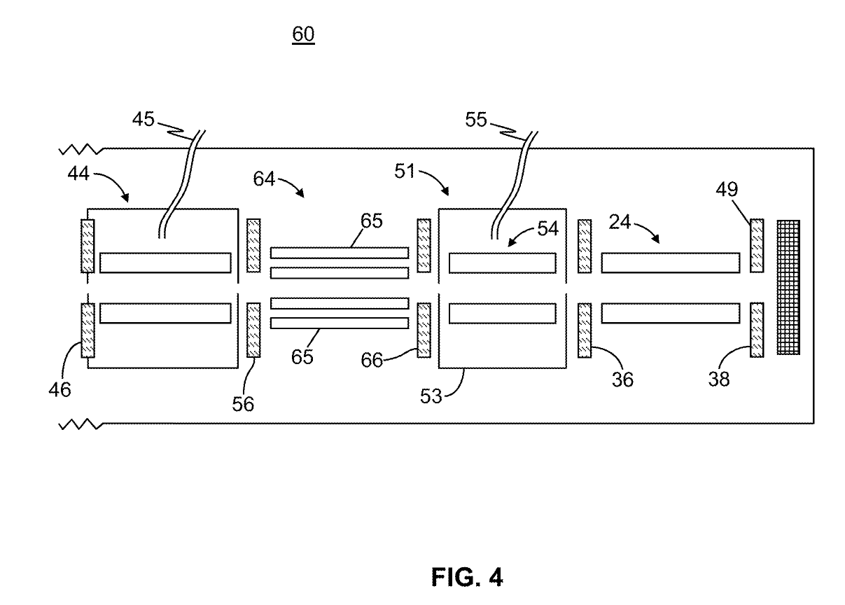

FIG. 4 illustrates a portion of a triple quadrupole mass spectrometer system 60 that has been further modified, relative to the system 50 illustrated in FIG. 3, by incorporation of an ion trap 64 between the collision cell 44 and the cooling cell 51. The ion trap 64 comprises a set of parallel rod electrodes 65 arranged in a multipole (e.g., quadrupole, octopole, etc.) configuration. An additional ion lens 66 is also provided between the ion trap and the cooling cell 51. In operation, the ion trap 64 may function as temporary storage for batches or packets of ions and, accordingly, the rods of the ion trap are operated in RF-only mode such that ions of all mass-to-charge ratios of interest may be stored in the ion trap. Nonetheless, a DC trapping voltage may be applied to all rods 65 of the ion trap, for ion trapping and ion flushing purposes, such that a DC potential difference may be applied between the rods 65 and the lens 56 and such that another DC potential difference may be applied between the rods 65 and the lens 66. One of ordinary skill in the art will appreciate that, although the rods 65 are illustrated in the attached drawings as being monolithic across their length, the rods could alternatively be segmented over their length with different DC voltages applied to the different segments to impose weak axial DC gradients. Another alternative would involve auxiliary electrodes located outside of the quadrupole rod electrode structure or in between adjacent rod electrodes may be used to impose axial gradients. There are a variety of approaches known in the art to achieve axial DC potential gradients for ion trapping and ion extraction.

During operation of the system 60, electrical potentials may be applied to lens 56, rods 65 and lens 66 such that incoming ions (passed from the collision cell 44 either with or without fragmentation) are passed into the ion trap through lens 56 but are prevented from exiting the trap through lens 66. Typically, the ion trap will be filled with ions up to its maximum capacity during this step. The filling of the ion trap in this fashion, over the course of a trapping time interval, Δt_{f}, generates an isolated batch or packet of ions and causes a homogenization (i.e., an averaging) of any ion abundance fluctuations that may occur over time periods shorter than Δt_{f}. After the completion of the introduction of the batch or packet of ions into the ion trap, the DC electrical potentials applied to the lenses 56, 66 and the trapping electrical potential applied to the rods 65 may be changed such that additional ions are prevented from entering the trap through lens 56. The trapped ions are emptied from the trap 64 by variably controlling DC electrical potentials applied to the ion lenses and to the rods of the ion trap, cooling cell and/or quadrupole mass filter so that the ions pass into and through the cooling cell 51 and into and through the quadrupole mass filter 24 with axial velocities approximately constant. The kinetic energy of the ions in each batch or packet is damped during their passage through the cooling cell as previously described. One of ordinary skill in the art will appreciate that axial or drag fields could be applied along the length of the ion trap 64 or along the length of the cooling cell 51 during either of these trapping and emptying steps.

According to some embodiments, the ions of each batch or packet may be m/z selectively extracted out of the ion trap over a period of time in the order of (or reverse order of) their m/z. This may be accomplished (Kaiser, N. K. et al., “Controlled Ion Ejection from an External Trap for Extended m/z Range in FT-ICR Mass Spectrometry”, J. Am. Soc. Mass Spectrometry, 25(6), 2014, pp. 943-949) by: (a) applying, during trapping, an auxiliary RF waveform on all rod electrodes of the ion trap such that the same auxiliary RF amplitude, same auxiliary RF frequency and same auxiliary RF phase is applied to all electrodes and then (b) progressively decreasing the auxiliary RF amplitude during extraction of ions from the trap. It has been found that, when such an auxiliary waveform is applied to rods of a RF 2D multipole ion trap, pseudo-potential barriers are created at each end of the device and that magnitude of these barriers depend quadradrically with the auxiliary RF amplitude and inversely with ion m/z. The mass selective release of ions from an ion trap in such fashion may be coordinated with the m/z scanning of a downstream quadrupole mass filter such that the quadrupole mass filter passes is set to pass (transmit) each particular m/z range of ions just at the same time that those m/z ions arrive at the quadrupole mass filter.

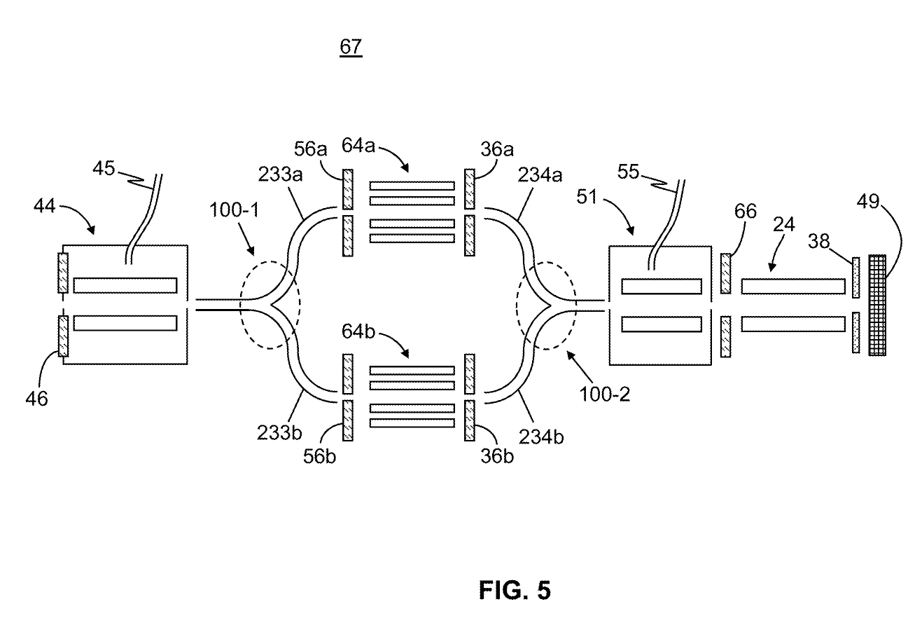

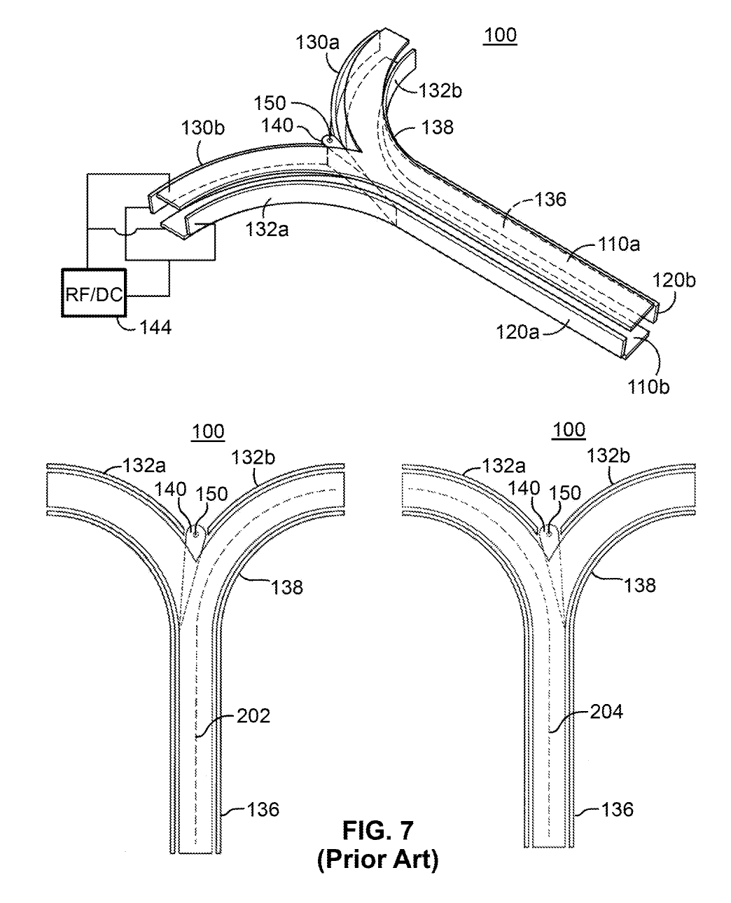

FIG. 5 illustrates a portion of another mass spectrometer system 67 in accordance with the present teachings that provides two parallel instances of the components illustrated in FIG. 4. The system 67 illustrated in FIG. 5 may be operated in a manner that increases the duty cycle of the quadrupole mass filter relative from that which may be achieved under operation of the system of FIG. 4. Accordingly, the system 67 comprises two instances of an ion trap—ion traps 64a, 64b between the collision cell 44 and the ion cooling cell 51. The first ion trap 64a may be operated in parallel with the second ion trap 64b. A stream of ions exiting the collision cell 44 may be diverted to one or the other of the two ion trap devices by a first switchable branched ion guide device 100-1. An example of a suitable form of switchable branched ion guide is illustrated in FIG. 7 and is discussed in more detail below with reference to that drawing. The ion cooling cell 51 may receive a batch or packet of ions exiting from either one of the two ion traps by the operation of a second switchable branched ion guide device 100-2 which is operated in a reverse sense as an ion path converging device.

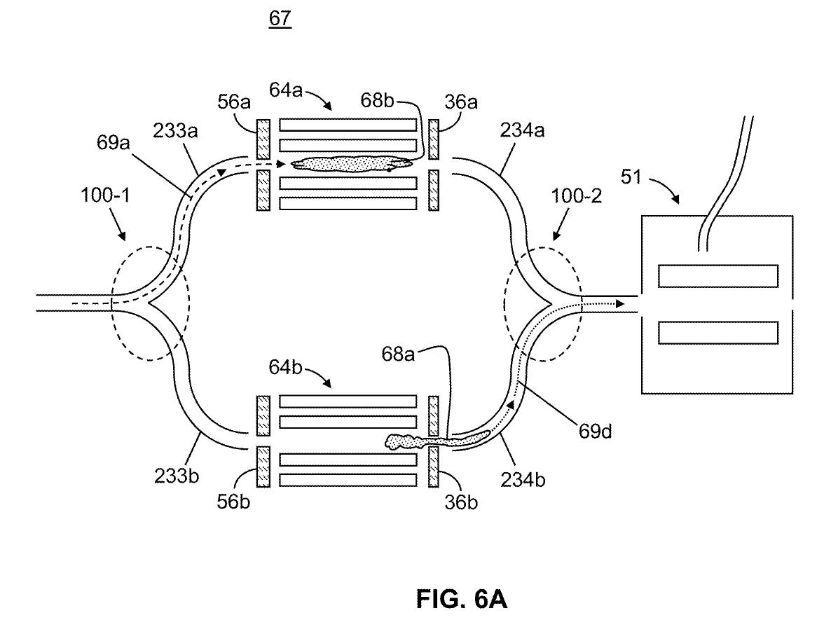

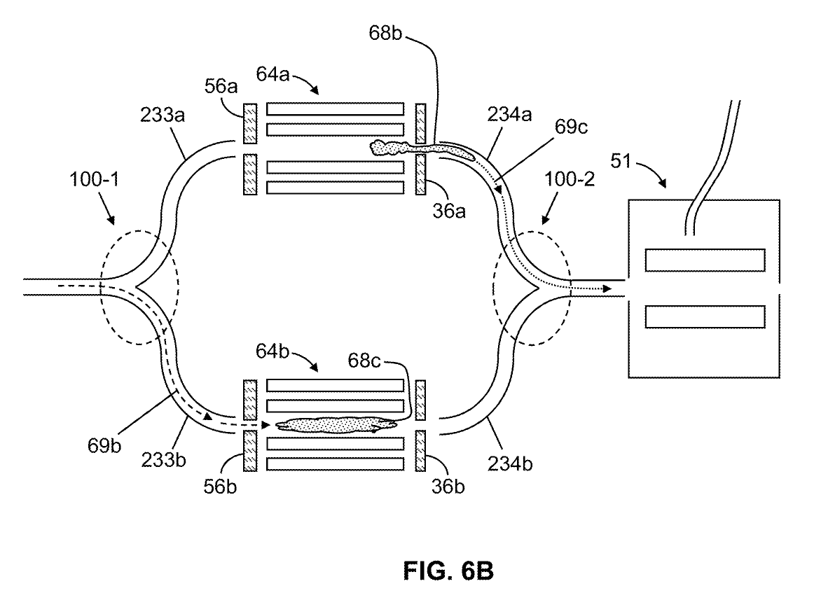

FIG. 6A illustrates a first operational configuration of the system 67. In accordance with the first operational configuration, an incoming stream of ions is directed by the first switchable branched ion guide so as to follow pathway 69a through ion conduit 233a. The ion conduits 233a, 233b, 234a, 234b may comprise simple extensions of the branch portions of the switchable branched ion guide devices 100-1 and 100-2 as discussed in greater detail below. Alternatively, the ion conduits 233a, 233b, 234a, 234b may comprise any form of ion guiding device, possibly curved and not necessarily completely physically surrounding the ion beam, such as sets of multiple rods or plate electrodes configured as 2D multipole ion guides or planar ion guides, or ion pipes comprising a plurality of rings electrodes, etc. In accordance with the first operational configuration, the stream of ions following pathway 69a passes through ion lens 56a so as to enter ion trap 64a. The DC voltages applied to ion lenses 56a, 36a and trapping voltage, if any, applied to the rods of ion trap 64a cause a batch or packet of ions 68b (indicated as a stippled cloud) to be trapped within the ion trap 64a.

At the same time that the batch or packet of ions 68b is being trapped within the ion trap 64a (FIG. 6A), an earlier-trapped batch or packet of ions 68a is being extracted from the ion trap 64b, so as to pass through ion lens 36b and into and through the ion conduit 234b along ion path 69d. In accordance with the first operational configuration, the second switchable branched ion guide device 100-2 is configured so as to direct the ion batch or packet 68a received from ion conduit 234b into and through the cooling cell 51 from which it is directed to a quadrupole mass filter (not illustrated). The release of the batch or packet of ions 68a out of the ion trap 64b may be controlled by DC voltages applied to lenses 56b and 36b and by a DC trapping voltage, if any, applied to the rods of ion trap 64b. Where there is physical provision, the application of DC voltages to segments of the rod electrodes or axillary rod electrodes for purposes of imposing an extractive DC potential gradient down the axis of the device may be used advantageously to effect improved ion extraction.

FIG. 6B illustrates a second operational configuration of the system 67. In the examples illustrated in FIG. 6B, it is assumed that this second operational configuration is applied immediately subsequent to the application of the first operational configuration as shown in FIG. 6A. As shown in FIGS. 6A and 6B, the change from the first to the second operational configuration of the system 67 includes switching of the configurations of both of the switchable branched ion guide devices 100-1 and 100-2. The change from the first to the second operational configuration of the system 67 also includes changing the voltages on the various ion lenses and electrodes such that incoming ions may be received, accumulated and trapped in the ion trap 64b and such that ions previously trapped in ion trap 64a are extracted out of that trap.

In accordance with the second operational configuration, the switchable branched ion guide 100-1 is configured so as to direct a new stream of ions along ion pathway 69b through ion conduit 233b. This stream of ions passes through ion lens 56b such that a third batch or packet of ions 68c is trapped in the ion trap 64b. At the same time that the batch or packet of ions 68c is being received, accumulated and trapped within the ion trap 64b (FIG. 6B), the batch or packet of ions 68b is being extracted from the ion trap 64a so as to pass into and through the ion conduit 234a along ion path 69c. In accordance with the second operational configuration of the system 67, the second switchable branched ion guide device 100-2 is configured so as to direct the ion batch or packet 68b received from ion conduit 234a to the ion cooling cell 51 from which it is directed to a quadrupole mass filter (not illustrated).

After the ion transfers illustrated in FIG. 6B have completed, the system 67 is once again set in the first operational configuration, as illustrated in FIG. 6A. Afterwards, the system is automatically alternately configured in the first and second configurations. In this fashion, the quadrupole mass filter does not remain in an idle state while an ion trap is being filled, since another ion trap is releasing ions to the quadrupole mass filter during the same time period. The controlled transfer of each batch or packet of ions from either one of the ion traps 64a, 64b to the quadrupole mass filter through the cooling cell 51 is effected by causing the ions of each such batch or packet to be mass-selectively extracted out of the ion trap over a period of time by creation of a controllable pseudo-potential barrier as described above. The mass-selective release of ions from an ion trap in such fashion may be coordinated with the mass scanning of a downstream quadrupole mass filter such that such that the quadrupole mass filter passes (transmits) each particular m/z range of ions just at the same time that those ions arrive at the quadrupole mass filter.

FIG. 7 illustrates a perspective view of an embodiment of a switchable branched ion guide 100 as may be included in the system 67 illustrated in FIGS. 6A, 6B. Switchable branched ion guides of the type illustrated in FIG. 7 are described in greater detail in U.S. Pat. No. 7,459,678 which is incorporated herein by reference. The switchable branched ion guide 100 includes a valve member 140 and is formed from an upper Y-shaped planar electrode 110a and a lower Y-shaped electrode 110b, and a plurality of side electrodes 120a, 120b, 130a, and 130b. The side electrodes are oriented generally orthogonally with respect to the planes of Y-shaped electrodes 110a and 110b. The orthogonal and side electrodes collectively define a first branch section 132a, a second branch section 132b, a trunk section 136, and a junction 138 connecting first and second branch sections 132a and 132b with trunk section 136. While upper and lower planar electrodes 110a and 110b are depicted as having monolithic structures, other implementations of the branched ion guide may utilize upper and lower electrodes having segmented structures.

As is known in the art, ions may be radially confined within the interior volumes of the branch and trunk sections by application of a suitable radio-frequency (RF) voltage to the various electrodes. More specifically, radial confinement is achieved by applying opposite phases of an RF voltage (supplied, for example, by RF/DC source 144) to Y-shaped electrodes 110a and 110b and to side electrodes 120a, 120b, 130a, and 130b. As is known in the art, an axial DC field may be generated by the use of auxiliary rods (as disclosed, for example, in U.S. Pat. No. 6,111,250 by Thomson et al.) or other suitable expedient to propel ions axially through ion guide 100. An inert gas, such as helium or nitrogen, may be added to the interior of ion guide 100 to provide kinetic cooling of the ions and to assist in focusing ions to the appropriate axis.

The pathway followed by ions within ion guide 100 is determined by controllably positioning valve member 140. According to the FIG. 7 embodiment, valve member 140 is configured as an elongated arm that is rotatably pivotable about a pivot point 150. While valve member 140 is depicted in the figures as having substantially straight or slightly curved side surfaces, in a preferred implementation of ion guide 100 valve member 140 is provided with opposing arcuate surfaces having curvatures that approximately match the corresponding curvatures of side electrodes 130a and 130b. Valve member 140 may be formed from an electrically conductive material (e.g., stainless steel) or from an insulator (e.g., ceramic) that is coated with a conductive material. Valve member 140 is placed in electrical communication with the side electrodes, for example by electrical contact with one of the side electrodes or via a separate connection to the RF voltage supply, such that a substantially quadrupolar field is generated that radially confines ions along the selected pathway. Because valve member 140 is preferably configured to minimize field inhomogeneity, the field that an ion experiences is essentially independent of its position along the first or second branch section.

The switching of switchable branched ion guide 100 is illustrated in the lowermost two diagrams of FIG. 7. In lower left diagram of FIG. 7, the valve member 140 is set in a first position in which ions are permitted to travel along pathway 202 between the interior volumes of trunk section 136 and the second branch section 132b, and are impeded from travel between the interior volumes of trunk section 136 and first branch 132a. In the lower right-hand diagram of FIG. 7, the valve member 140 has been rotated about pivot point 150 to a second position in which ions may travel between the interior volumes of first branch section 132a and trunk section 136 along pathway 204, but are impeded from travel between second branch section 132b and trunk section 136. Movement of valve member 140 between the first and second position may be accomplished by one of variety of mechanisms known in the art, including without limitation electromechanical actuators, piezoelectric actuators, hydraulic actuators, and magnetic actuators.

It is to be noted that the ion guide 100 is inherently bidirectional, and may be configured such that ions travel from the trunk section 136 to a selected one of the branch sections, or alternatively from a selected one of the branch sections to the trunk section 136. The switchable branched ion guide devices 100-1 and 100-2 need not be of the same form as the apparatus illustrated in FIG. 7 and need not operate in the same fashion as that apparatus. Any suitable types of switchable branched ion guide device may be employed as one or both of the switchable branched ion guide devices 100-1 and 100-2. For example, U.S. Pat. No. 7,420,161 and U.S. Pat. No. 7,829,850, both in the name of inventor Kovtoun, teach switchable branched ion guides that operate according to a different principle from that of the apparatus illustrated in FIG. 7. Whereas the apparatus illustrated in FIG. 7 includes a mechanically moveable valve member that assists in ion path switching, the switchable branched ion guide devices taught in U.S. Pat. No. 7,420,161 and U.S. Pat. No. 7,829,850 effect such path switching through the use of a plurality of fixed-position electrodes. In operation of these apparatuses, an RF voltage source applies RF voltages to at least a portion of the plurality of electrodes to establish RF fields that radially confine ions within the ion channels. By adjusting the phase and/or magnitude of the RF voltages applied to one or more electrodes, the ions are caused to preferentially travel along a first or a second ion channel. The switchable branched ion guide devices taught in U.S. Pat. No. 7,420,161 and U.S. Pat. No. 7,829,850 are bi-directional devices.

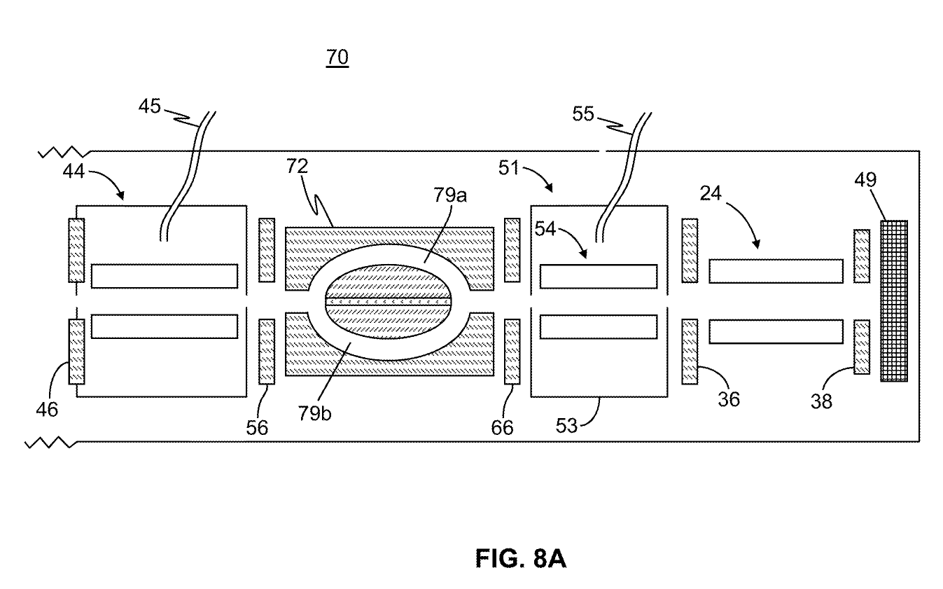

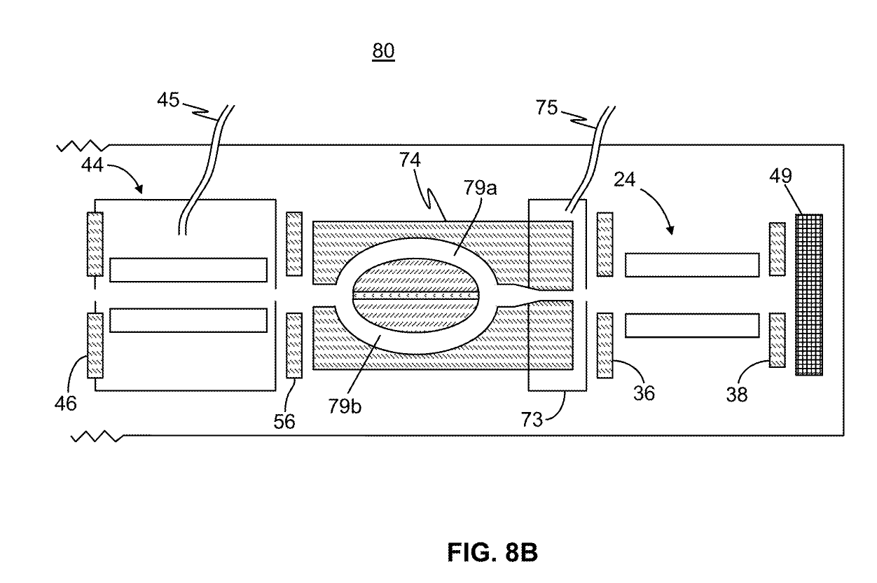

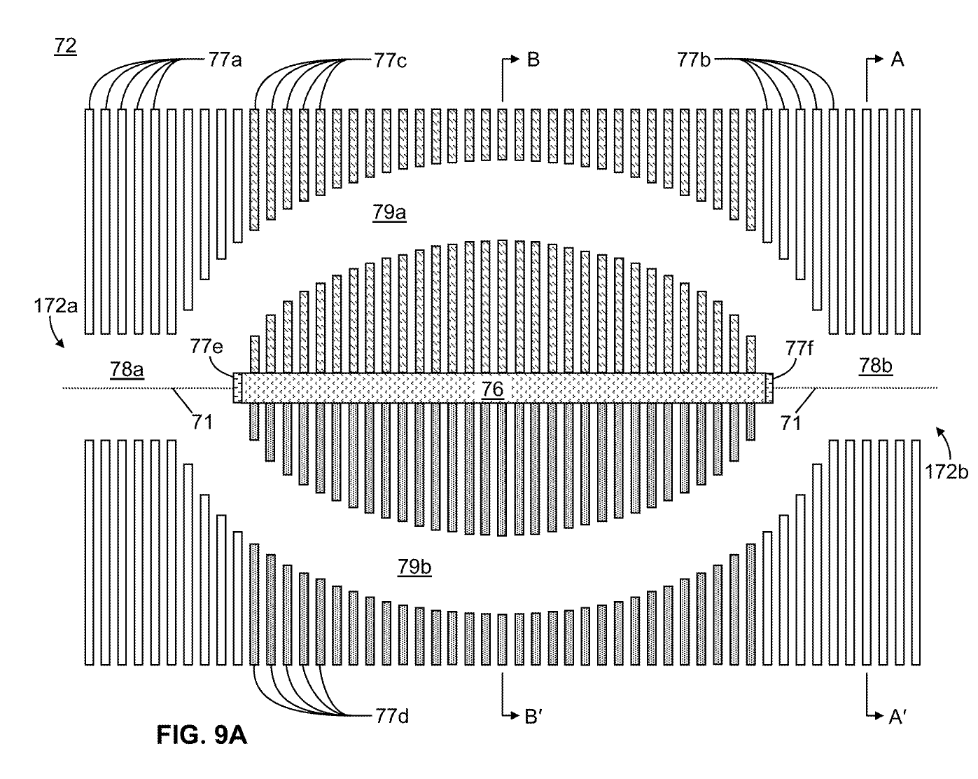

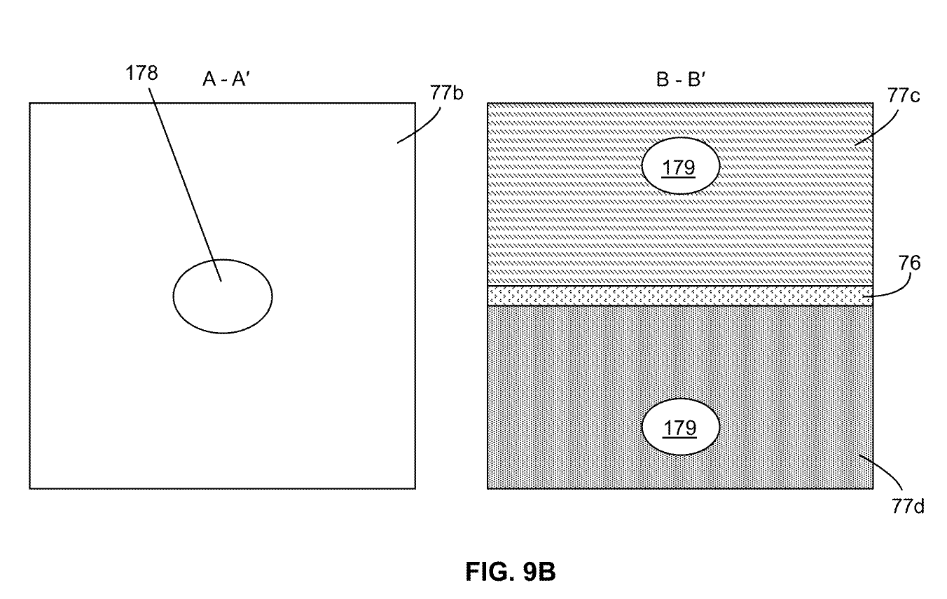

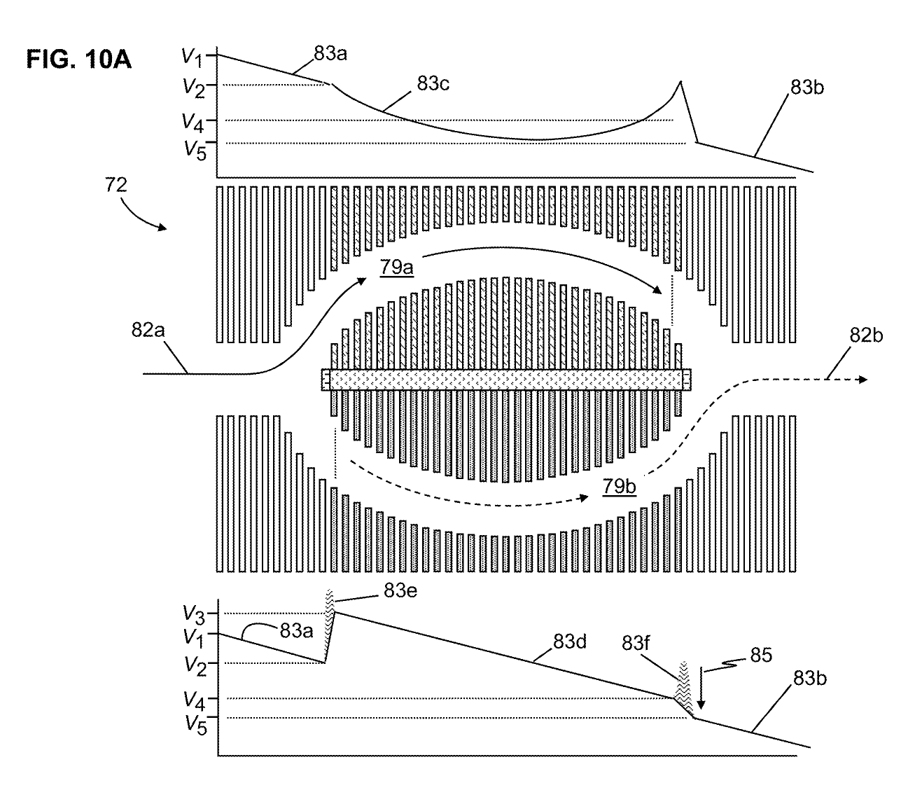

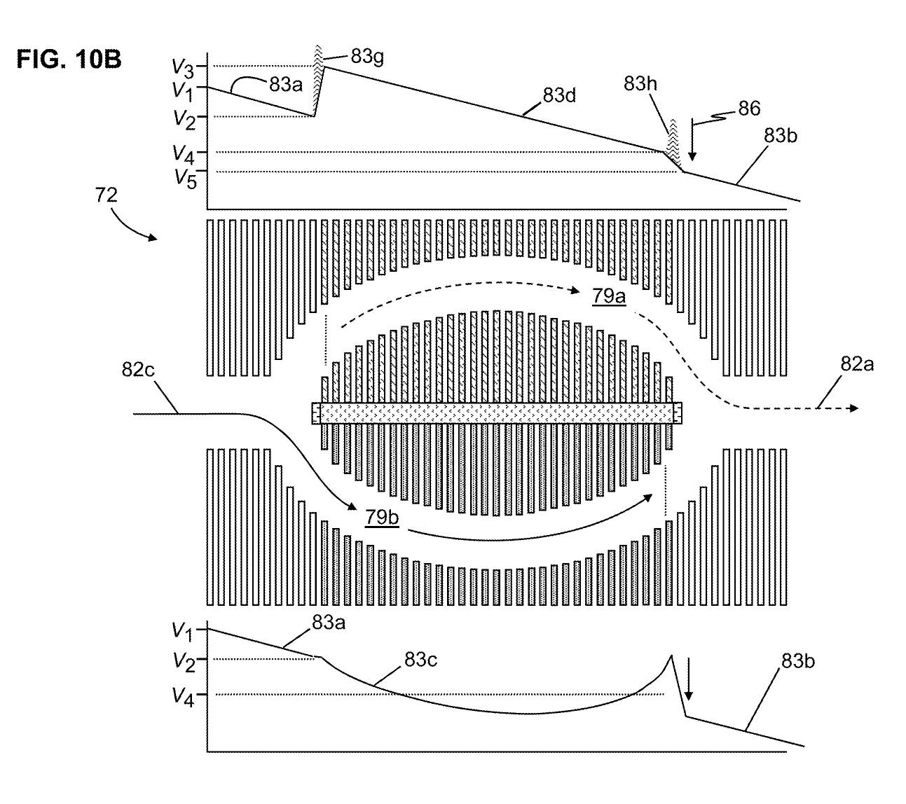

FIG. 8A is a schematic depiction of a portion of another triple-quadrupole mass spectrometer system 70 that employs a novel switchable branched ion trap apparatus 72 in accordance with the present teachings. The system 70 illustrated in FIG. 8A is similar to the system 60 depicted in FIG. 4 except that the ion trap 64 of the latter system is replaced by a switchable branched ion trap apparatus 72. The switchable branched ion trap apparatus 72 is disposed between the collision cell 44 and the cooling cell 51 and comprises a pair of curved ion conduits 79a, 79b, either of which may be employed as an ion trap. An ion lens 56 may be disposed between the collision cell 44 and an inlet end of the switchable branched ion trap apparatus 72. Likewise, an ion lens 66 may be disposed between an outlet end of the switchable branched ion trap apparatus 72 and the cooling cell 51. The structural details of an exemplary embodiment of such a switchable branched ion trap apparatus are discussed further below in reference to FIGS. 9A, 9B, 10A and 10B. As discussed in greater detail below, the switchable branched ion trap apparatus 72 replaces the pair of switchable branched ion guides and pair of ion traps depicted in FIG. 5, FIG. 6A and FIG. 6B.

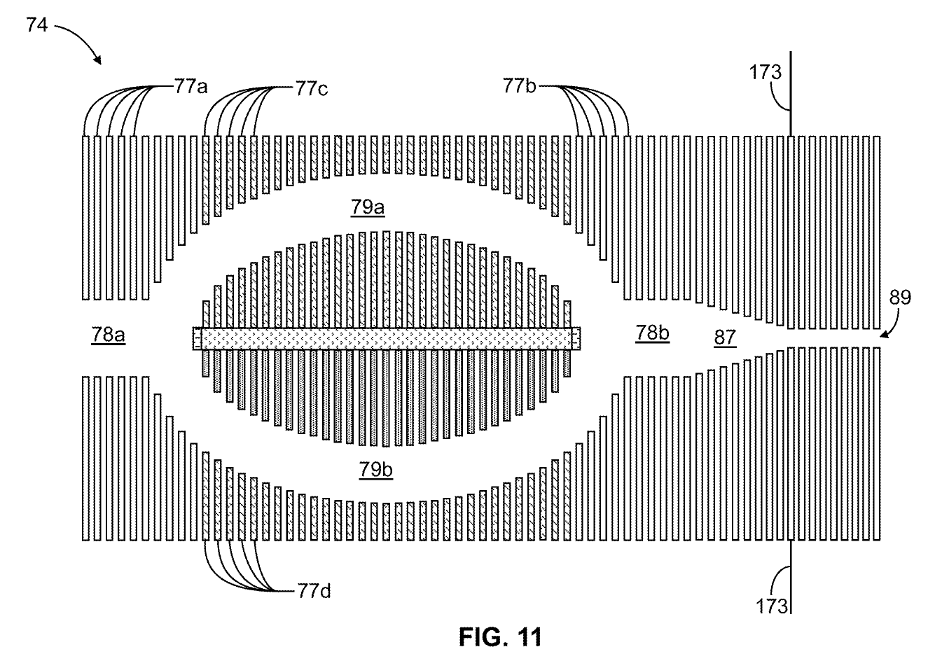

FIG. 8B is a schematic depiction of a portion of another triple-quadrupole mass spectrometer system 80 in accordance with the present teachings. In contrast to the system 70 illustrated in FIG. 8A, the system 80 of FIG. 8B does not include a separate ion cooling cell (such as the ion cooling cell 51 shown in FIG. 8A). Instead, the functionality of both the cooling cell and the switchable branched ion trap apparatus (apparatus 72 of FIG. 8A) is provided by a modified version of the switchable branched ion trap apparatus, which is depicted in FIG. 8B as switchable branched ion trapping and cooling apparatus 74. The switchable branched ion trapping and cooling apparatus 74 includes an extended portion, relative to the previously-described apparatus 72, that is disposed within a partially enclosed container 73 into which a suitable inert gas is supplied, through gas supply tube 75. Accordingly, the switchable branched ion trapping and cooling apparatus 74 is partially disposed within the container 73 and partially disposed outside of the container 73. The inert gas is supplied into the container 73 at a pressure that is sufficient to damp the kinetic energy of ions being transported within an outlet conduit of the apparatus 74 but that is insufficient to cause fragmentation of the ions. In this fashion, the extended portion of the apparatus 74 functions as an ion cooling portion of the apparatus. The structural details of an exemplary embodiment of such a switchable branched ion trapping and cooling apparatus are described below in reference to FIG. 11.

FIGS. 9A and 9B respectively illustrate a longitudinal cross sectional view and two transverse cross sectional views of a switchable branched ion trap apparatus 72, as may be employed in the system 70, in accordance with the present teachings. The apparatus 72 comprises a plurality of apertured thin electrodes or ring electrodes 77a, 77b, 77c, 77d that are configured in a stacked configuration. An “apertured thin electrode”, as the term is used herein, is an electrode, preferably but not necessarily in plate or plate-like form, having an aperture, where the smallest diameter of the aperture is greater than the thickness of the electrode or plate. The apertured thin electrodes may be disposed, in preferred embodiments, substantially parallel to one another, but such parallelism is not required. An insulating or supporting member 76 may be disposed between electrodes 77c and 77d, preferably along the central axis 71 of the apparatus. Additional or alternative insulating or supporting or insulating components (not illustrated for clarity of presentation) may be disposed in the planar gaps between successive electrodes or at the outer edges of electrodes. Additional separate electrodes 77e, 77f may be disposed at the respective ends of the insulating or supporting member 76.

FIG. 9B, which illustrates transverse cross sections along section lines A-A and B-B whose locations are indicated in FIG. 9A, depicts a single apertured thin electrode 77b on the left-hand side and one each of apertured thin electrodes 77c and 77d on the right-hand side. Each of the apertured thin electrodes 77b (as well as each of the apertured thin electrodes 77a) comprises an aperture 178. Each of the apertured thin electrodes 77c and 77d comprises an aperture 179. Although the apertured thin electrodes are depicted as rectangular plates in FIG. 9B, the apertured thin electrodes need not be rectangular and need not be in plate form and could comprise any shape that is suitable for mounting in a particular apparatus. Although the apertures 178, 179 are illustrated as elliptical in shape in FIG. 9B, these apertures are not restricted to any particular form and could alternatively be circular in shape or of any other shape. Further, the apertures need not all have the same shape.

The central axis 71 of the apparatus 72 passes through the apertures 178 of apertured thin electrodes 77a and apertured thin electrodes 77b and, preferably, through the centers of these apertures. The apertured thin electrodes 77c and 77d are oppositely disposed with respect to the axis 71 as illustrated in FIG. 9A and FIG. 9B. Therefore, the axis 71 does not pass through the apertures 179 of apertured thin electrodes 77c and 77d. Preferably, the apertures of the electrodes apertured thin electrodes 77c and the apertures of the apertured thin electrodes 77d are diametrically opposed to one another with respect to the axis 71.

As illustrated in FIG. 9A, the plurality of apertures 178 of apertured thin electrodes 77a define an inlet ion conduit 78a that is disposed at an inlet end 172a of the apparatus 72 and the plurality of apertures 178 of apertured thin electrodes 77b define an outlet ion conduit 78b that is disposed at an outlet end 172b of the apparatus. The plurality of apertures 179 of apertured thin electrodes 77c define a first curved ion trapping conduit 79a and the plurality of apertures 179 of apertured thin electrodes 77d define a second curved ion trapping conduit 79b. The curvature of the ion trapping conduits 79a, 79b is caused by the varying displacement of the apertures 179—either away from or towards the central axis 71—between each electrode and the successive electrode. As may be seen from FIG. 9A, the apertures 179 and the widths of at least some of the apertures 178 are configured such that the two ion trapping conduits 79a, 79b either converge to or diverge from each of the inlet and outlet ion conduits 78a, 78b.

In operation, the electrodes of the switchable branched ion trap apparatus 72 are electrically coupled to one or more voltage sources that can supply an oscillatory primary RF voltage to the set of apertured thin electrodes such that the instantaneous voltage applied to every successive apertured thin electrode is 180-degrees (t radians) out of phase with the voltage applied to the preceding electrode. By the application of the RF voltage in this fashion, ions may be confined within any of the ion conduits 78a, 78b, 79a and 79b in similarity to known stacked ring ion guide, ion pipe and ion funnel apparatuses. Further, the electrical couplings between the apparatus 72 and the one or more voltage sources are such that the individual DC voltages applied to electrodes may correspond to various DC voltage gradients or voltage profiles and that they may be applied, independently, to each of the set of apertured thin electrodes 77a, the set of apertured thin electrodes 77b, the set of apertured thin electrodes 77c and the set of apertured thin electrodes 77d. Also the DC voltages applied to the apertured thin electrodes 77e and 77f may be switched, independently of one another, so as to conform to a voltage profile applied to either the set of apertured thin electrodes 77c or the set of apertured thin electrodes 77d. In this fashion, incoming ions (entering the apparatus 72 at inlet end 172a and passing through inlet ion conduit 78a) may be deflected to either of the curved ion conduits 79a, 79b and ions may be either independently trapped within or released out of either of the curved ion conduits.

Further, in accordance with some embodiments, the electrical couplings between the apparatus and the one or more voltage sources may be such that an auxiliary RF voltage may be superimposed on any other voltages or voltage waveform applied to the set of apertured thin electrodes 77c, or to the set of apertured thin electrodes electrodes 77d, where the auxiliary RF voltage is applied such that the same auxiliary RF phase, same auxiliary RF frequency and same auxiliary RF amplitude is applied to all of the electrodes of each electrode set 77c or 77d generally but not to both electrode sets 77c and 77d at the same time. The application of an auxiliary RF voltage in this fashion permits ions to be “leaked” from either of the curved ion trapping conduits to the outlet ion conduit 78b in reverse order of their mass-to-charge ratios, as described further below. Such mass-selective release of ions out of the switchable branched ion trap apparatus 72 can be controllably operated such that such a downstream quadrupole mass filter passes each particular m/z range of ions just at the same time that those ions arrive at the quadrupole mass filter after having been released from one of the ion traps. According to some embodiments, the quadrupole mass filter may be scanned so as to pass ions therethrough in reverse order of their mass-to-charge ratios, but such reverse scanning of the mass filter is not a necessity.

FIGS. 10A and 10B are schematic depictions of a first and a second operational configuration, respectively, of the switchable branched ion trap apparatus 72 of FIGS. 9A and 9B. In operation, the switchable branched ion trap apparatus 72 is included within a mass spectrometer system, such as the mass spectrometer system 70 schematically shown in FIG. 8A. Accordingly, the different operational configurations illustrated in FIGS. 10A and 10B may correspond to alternative pathways by which ions may be routed to the downstream ion cooling cell 51 and then to the quadrupole mass filter 24 within the mass spectrometer system 70. Taken together, the first and second operational configurations of the switchable branched ion trap apparatus 72 correspond to those depicted in FIGS. 6A and 6B in which operation is such that as one ion trap is releasing ions to a cooling cell, a second ion trap is accumulating ions into a batch or packet of ions so as to average ion abundance fluctuations. With regard to the apparatus illustrated in FIGS. 10A and 10B, the ion trapping occurs within the first and second curved ion trapping conduits 79a, 79b.

Exemplary hypothetical schematic DC voltage profiles over the length of the switchable branched ion trap apparatus 72 are illustrated in the uppermost and lowermost portions of FIGS. 10A and 10B. It is understood that the illustrated DC voltage profiles are superimposed on any other voltages that may be applied to the electrodes, such as oscillatory RF voltages. The DC voltage profile 83a in the lowermost portion of each figure is identical to the voltage profile 83a in the uppermost portion of the respective figure, since both profiles pertain to DC voltages applied to aperture electrodes 77a. A similar statement holds true with regard to the DC voltage profile 83b shown in each of FIGS. 10A and 10B, since both the uppermost and lowermost DC voltage profiles 83b of each figure pertain to DC voltages applied to apertured thin electrodes 77b.

In the configuration shown in FIG. 10A, the voltage profiles applied to apertured thin electrodes 77a, apertured thin electrodes 77c and apertured thin electrodes 77d (FIG. 9A) are such that incoming ions are diverted, along solid-line pathway 82a, to curved ion conduit 79a and are prevented from entering curved ion conduit 79b. The ions continue to move down an electrical potential gradient at the entrance into curved ion conduit 79a but encounter a DC electrical potential barrier of magnitude V₃-V₁ at the entrance to curved ion conduit 79b. The ions flowing into curved ion conduit 79a reach a potential minimum at some point within the confines of conduit which prevents further flow of these ions into outlet conduit 78b (FIG. 9A). Thus, the ions following pathway 82a in FIG. 10A are trapped in curved ion conduit 79a. The accumulation of ions in this fashion averages any short-term random ion abundance fluctuations in an incoming ion stream. Although the DC voltage profiles are illustrated as either sloping lines or curves in FIGS. 10A and 10B, they may be replaced by other forms, such as constant-potential wells, in the portions of the apparatus used for trapping.

At the same time that ions are being trapped in curved ion conduit 79a, a previously-trapped batch or packet of ions is being flushed out of curved ion conduit 79b by means of a DC potential gradient along profile 83d applied to electrodes 77d (FIG. 9A). At the boundary between electrodes 77d and electrodes 77b, the ions encounter a further potential decrease and thus continue to flow out of the apparatus 72 along dashed-line ion pathway 82b through outlet conduit 78b.

If no auxiliary RF potential is applied to electrodes 77d, then only the solid voltage profile line comprising voltage profiles 83a, 83d and 83b need be considered. In such a case, it may be seen that, according to the example illustrated in FIG. 10A, the applied DC potential continues to decrease along the a gradient at the boundary between electrodes 77d and electrodes 77b and thus ions flowing out of curved ion conduit 79b are flushed out of the apparatus 72 along ion pathway 82b.

If an auxiliary RF voltage is applied to all of the electrodes 77d such that all electrodes receive the same amplitude, frequency and phase, then a pair of pseudo-potentials 83e and 83f will be generated at the boundary between electrodes 77a and 77d and at the boundary between electrodes 77d and 77b. The first of these pseudo-potentials 83e is produced by the resulting auxiliary RF voltage gradient between electrode set 77a (FIG. 9A) and the electrode set 77d (FIG. 9A). The second of these pseudo potentials 83f is produced by the resulting auxiliary RF voltage gradient between the electrode set 77d and the electrode set 77b. In FIG. 10A these pseudo-potentials are represented as shaded areas on top of the segments of the DC voltage profiles. The pseudo potential 83e just adds to the effect of DC barrier potential (approximately V₃−V₁) that prevents ions from entering the curved ion conduit 79b. However the pseudo-potential 83f may act as a barrier preventing ion extraction from the curved ion conduit 79b. The portion of the shaded area representing the pseudo-potential 83f that extends higher than voltage V₄ schematically represents the height of this effective potential barrier for a given m/z. The height of this potential barrier varies according to m/z ratio since, as generally known, the intensity of pseudo-potentials varies inversely with m/z.

It has been found (Kaiser, N. K. et al., “Controlled Ion Ejection from an External Trap for Extended m/z Range in FT-ICR Mass Spectrometry”, J. Am. Soc. Mass Spectrometry, 25(6), 2014, pp. 943-949) that when such an auxiliary RF voltage is applied to rod electrodes of a 2D quadrupole ion trap apparatus, a pseudo-potential is created at the ends of the device such that ions may be released from the ion trap sequentially in order from high m/z to low m/z by a controlled decrease in amplitude of the auxiliary RF amplitude.

The present inventors have applied the above finding of controlled release of ions of progressively decreasing m/z to the apparatus 72. The pseudo-potential, 83f above voltage V₄ in FIG. 10A may thus be understood as a schematic representation of the magnitude of the effective barrier preventing release of ions from the curved ion conduit 79b to the outlet ion conduit 78b, where ions of progressively decreasing m/z would experience correspondingly higher pseudo-potential barrier. Progressive decreasing of the amplitude of the applied auxiliary RF voltage is represented as a controlled lowering (as indicated by downward pointing arrow 85) of the pseudo-potential barrier 83f as the magnitude of the pseudo-potential will vary as the square of magnitude the applied auxiliary RF voltage. Through this progressive lowering of the pseudo-potential barrier 83f, the extractive voltage gradient imposed by the voltage difference between DC voltage V₄ applied to the last electrode of the electrode set 77d and the DC voltage V₅ applied to the first electrode of the electrode set 77b is sufficient enable ions of progressively lower m/z to transit through the pseudo-potential and pass into and through the curved ion conduit 79b. Although the above description of pseudo-potential generation has assumed that an auxiliary RF voltage is applied to all of the electrodes 77d such that all electrodes receive the same amplitude, frequency and phase, it should be noted that one of ordinary skill in the art may envisage alternative configurations of electrodes and/or associated applied auxiliary RF voltage or a set of auxiliary RF voltages to generate an adjustable pseudo-potential barrier in such a region.

The mass-selective release of ions of each batch or packet is coordinated with the mass scanning of a downstream quadrupole mass filter such that ions of a given m/z range are released from the ion channel 79b and transit through ion channel 78b at a time such that they will arrive at the entrance of the quadrupole mass filter when the quadrupole mass filter is passing (m/z selectively transmitting) ions of a similar m/z range. Improper coordination of the m/z selective release of ions from ion channel 79b may result in few or no ions within the m/z range being selected by the quadrupole mass filter actually being delivered to it. If such ions are release belatedly from ion conduit 79b, these ions would still be retained in ion conduit 79b during the time interval when they would transmit through the mass filter, only to be released later when the mass filter is no longer set to transmit that range of ions of that m/z range (when it is passing a different range of m/z). If such ions are released too early from ion conduit 79b, they will reach the mass filter when it is transmitting ions of a different m/z range and be lost. However with proper coordination in the scanning of the window of m/z transmission (selection) of the mass filter and the m/z threshold of m/z selective release of ions from ion trapping apparatus 72 result in an increase in ion transmission and therefore instrument sensitivity as the a much larger fraction of the ions accumulated in the ion trapping apparatus will be delivered to the mass filter when they are likely to be transmitted. Further, variable DC electrical potential differences between the switchable branched ion trap apparatus 72 and the quadrupole mass filter may be adjustably controlled such that ions pass into and through the quadrupole mass filter at a nominally common velocity of transit, irrespective of their m/z ratio.

The operation of the apparatus 72 in its second operational configuration (shown in FIG. 10B) is similar to the operation as shown in FIG. 10A, except that the voltage profiles applied to apertured thin electrodes 77c and 77d are reversed from those illustrated in FIG. 10A. Thus, in the illustrated example of the second operational configuration, the voltage profile 83c is applied across the set of electrodes 77d and the voltage profile 83d is applied across the set of electrodes 77c. Accordingly, when operated in the second operational configuration, an incoming stream of ions is directed into and trapped within curved ion conduit 79b along ion pathway 82c while, at the same time, an ion batch or packet that was previously trapped within curved ion conduit 79a is released out of that curved ion conduit and out of the apparatus along ion pathway 82d. In the second operational configuration, the auxiliary RF voltage, if any, is applied to apertured thin electrodes 77c. The resulting pseudo-potential barriers at either end of ion conduit 79a are depicted as the shaded regions. Extended operation of the apparatus 72 alternates between the two operational configurations illustrated in FIGS. 10A and 10B.

FIG. 11 illustrates one example of switchable branched ion trapping and cooling apparatus 74 in accordance with some embodiments in accordance with the present teachings. The apparatus 74 differs from the previously-described switchable branched ion trap apparatus 72 in that at least a portion of the electrodes 77b comprises a set of apertures that decrease in size in progression towards the outlet end of the apparatus so as to define a funnel-shaped ion outlet conduit portion 87 of the apparatus. Another portion of the electrodes 77b disposed further towards the outlet end of the apparatus may comprise a set of apertures of constant size so as to define a reduced-diameter conduit portion 89 between opposing electrodes of the other portion. The boundary between the funnel-shaped ion outlet conduit portion 87 and the reduced-diameter conduit portion 89 may align with a wall 173 of the container 73 that receives a supply of inert gas through gas supply tube 75 (see FIG. 8B). Thus, the reduced diameter of the reduced-diameter conduit portion 89 may function as an ion cooling portion of the apparatus 74. The same reduced-diameter conduit portion may also function as a gas-flow-limiting aperture that limits the flow of damping gas into the curved ion conduits 79a, 79b which are maintained at a lower pressure at (higher vacuum) than the cooling portion of the apparatus. The pressure in the curved ion conduits must be sufficiently high to enable efficient trapping and accumulation of injected ions but not so high as to overly extend the time of ion extraction. The physical design of apparatus 74 is such that the gas conductances between the cooling portion of the reduced diameter conduit portion 89, the curved ion conduits 79a, 79b and the enclosing high-vacuum chamber (e.g., high-vacuum chamber 23 of FIG. 1) and its associated evacuation (pumping) system maintain these pressures for appropriately set damping gas flows through the gas supply tube 75.

The discussion included in this application is intended to serve as a basic description. Although the present invention has been described in accordance with the various embodiments shown and described, one of ordinary skill in the art will readily recognize that there could be variations to the embodiments or combinations of features in the various illustrated embodiments and those variations or combinations of features would be within the spirit and scope of the present invention. The reader should thus be aware that the specific discussion may not explicitly describe all embodiments possible; many alternatives are implicit. Accordingly, many modifications may be made by one of ordinary skill in the art without departing from the scope and essence of the invention. Neither the description nor the terminology is intended to limit the scope of the invention—the invention is defined only by the claims. Any patents, patent applications or other publications mentioned herein are hereby explicitly incorporated herein by reference in their respective entirety.

1. A method for operating a mass spectrometer, comprising:
generating a stream of ions by an ion source;
directing the stream of ions into a first one of a pair of ion storage locations and trapping a first portion of the stream of ions therein;
directing a packet of ions from the other one of the pair of ion storage locations to and through an ion cooling cell that damps the kinetic energy of ions of the packet of ions;
directing the packet of ions from the ion cooling cell to a mass analyzer of the mass spectrometer for mass analysis of the ions of the packet of ions thereby;
directing the first portion of the stream of ions from the first one of the pair of ion storage locations to and through the ion cooling cell; and
directing the first portion of the stream of ions from the ion cooling cell to the mass analyzer for mass analysis of ions of the first portion of the stream of ions thereby.

2. A method as recited in claim 1, wherein the directing of the packet of ions from the other one of the pair of ion storage locations to and through the ion cooling cell is performed simultaneously with the directing of the stream of ions into the first one of the pair of ion storage locations.

3. A method as recited in claim 1, further comprising:
directing the stream of ions into the other one of the pair of ion storage locations and trapping a second portion of the stream of ions therein.

4. A method as recited in claim 3, wherein the directing of the stream of ions into the other one of the pair of ion storage locations is performed simultaneously with the directing of the first portion of the stream of ions from the first one of the pair of ion storage locations to and through the ion cooling cell.

5. A method as recited in claim 3, wherein each one of the trapping of the first portion of the ions and the trapping of the second portion of the ions is performed by trapping the respective portion of the ions in a respective one of a pair of ion traps, each ion trap comprising a plurality of apertured thin electrodes, each apertured thin electrode comprising an aperture therein.

6. A method as recited in claim 5, wherein the plurality of apertured thin electrodes are mutually parallel.

7. A method as recited in claim 3, wherein each one of the trapping of the first portion of the ions and the trapping of the second portion of the ions is performed by trapping the respective portion of the ions in a respective one of a pair of ion traps, each ion trap comprising a multipole apparatus comprising a plurality of rod electrodes.

8. A method as recited in claim 3, wherein each one of the directing of the stream of ions into the first one of the pair of ion storage locations and the directing of the stream of ions into the other one of the pair of ion storage locations comprises:
causing the stream of ions to pass through a first conduit defined by a plurality of apertures, each aperture disposed in a respective apertured thin electrode of a first plurality of apertured thin electrodes; and
causing the stream of ions to pass into a second conduit defined by a second plurality of apertures, each aperture disposed in a respective apertured thin electrode of a second plurality of apertured thin electrodes, wherein the first and second conduits are non-coaxial.

9. A method as recited in claim 8, wherein the apertured thin electrodes of the first and second pluralities of apertured electrodes are mutually parallel.

10. A method as recited in claim 1, wherein the step of directing the packet of ions from the other one of the pair of ion storage locations to and through the ion cooling cell comprises:
varying a pseudopotential barrier between a first plurality of apertured thin electrodes and a second plurality of apertured thin electrodes such that ions of the ion packet are transferred, in reverse order of their mass-to-charge ratios, from a first ion conduit defined by a first plurality of apertures to a second conduit defined by a second plurality of apertures, wherein each of the first plurality of apertures is disposed within a respective one of the first plurality of apertured thin electrodes and each of the second plurality of apertures is disposed within a respective one of the second plurality of apertured thin electrodes.

11. A method as recited in claim 8, wherein the apertured thin electrodes of the first and second pluralities of apertured thin electrodes are mutually parallel.

12. A method as recited in claim 1,
wherein the directing of the packet of ions from the other one of the ion storage locations to and through the ion cooling cell comprises mass-selectively releasing the ions of the packet of ions from said other one of the ion storage locations in reverse order of mass-to-charge ratio over a period of time,
wherein the mass analysis of the ions of the packet of ions is performed in reverse order of mass-to-charge ratio over a second period of time, and
wherein the mass analysis of the ions of the packet of ions over the second period of time is coordinated with the mass-selective releasing of the packet of ions of the first period of time.

13. An apparatus, comprising:
a plurality of first apertured thin electrodes disposed in a stacked relationship relative to one another, each first apertured thin electrode comprising a respective plane having a respective first aperture therein, the plurality of first apertures defining a first ion conduit, the first ion conduit defining an ion pathway through a portion of the apparatus, said ion pathway being transverse to the planes of the first apertured thin electrodes;
a plurality of second apertured thin electrodes disposed in a stacked relationship relative to one another, each second apertured thin electrode comprising a respective plane having a respective second aperture therein, the plurality of second apertures defining a second ion conduit, the second ion conduit defining a second ion pathway through a second portion of the apparatus, said second ion pathway being transverse to the planes of the second apertured thin electrodes;
a plurality of third apertured thin electrodes disposed in a stacked relationship relative to one another and disposed between the plurality of first apertured thin electrodes and the plurality of second apertured thin electrodes, each third apertured thin electrode comprising a respective plane having a respective third aperture therein, the plurality of third apertures defining a curved third ion conduit disposed between and non-coaxial with the first and second ion conduits, the third ion conduit defining a third ion pathway through a third portion of the apparatus, said third ion pathway being transverse to the planes of the third apertured thin electrodes;
a plurality of fourth apertured thin electrodes disposed in a stacked relationship relative to one another and disposed between the plurality of first apertured thin electrodes and the plurality of second apertured thin electrodes, each fourth apertured thin electrode comprising a respective plane having a respective fourth aperture therein, the plurality of fourth apertures defining a curved fourth ion conduit disposed between and non-coaxial with the first and second ion conduits, the fourth ion conduit defining a fourth ion pathway through a fourth portion of the apparatus, said fourth ion pathway being transverse to the planes of the fourth apertured thin electrodes; and
an electrical power supply electrically coupled to each apertured thin electrode of the first plurality, second plurality, third plurality and fourth plurality of apertured thin electrodes and configured to apply an oscillatory radio-frequency (RF) voltage and a respective direct-current (DC) voltage to each of said apertured thin electrodes, such that, within each stacked relationship, a phase of the RF voltage applied to each apertured thin electrode differs by π from the phase of each adjacent apertured thin electrode.

14. An apparatus as recited in claim 13, further comprising an electrically insulating member disposed between the plurality of third apertured thin electrodes and the plurality of fourth apertured thin electrodes.

15. An apparatus as recited in claim 13, wherein the apertured thin electrodes of the first, second, third and fourth pluralities of apertured thin electrodes are mutually parallel.

16. An apparatus as recited in claim 13, wherein the electrical power supply is further configured to apply an auxiliary RF voltage to at least a portion of the third apertured thin electrodes and to at least a portion of the fourth apertured thin electrodes, wherein a same auxiliary RF amplitude, a same auxiliary RF frequency and a same auxiliary RF phase is applied to all apertured thin electrodes of the at least a portion of the third apertured thin electrodes and the at least a portion of the fourth apertured thin electrodes.

17. An apparatus as recited in claim 13, wherein diameters of apertures of a portion of the plurality of second apertured thin electrodes progressively decrease in a direction away from the third and fourth ion conduits.

18. An apparatus as recited in claim 17, further comprising:
another portion of the plurality of second apertured thin electrodes; and
a gas supply tube fluidically coupled to the apertures of the other portion of the plurality of second apertured thin electrodes.

19. An apparatus as recited in claim 13,
wherein the first ion conduit comprises a first end that is an ion inlet of the apparatus and a second end,
wherein the second ion conduit comprises a first end and a second end, the second end being an ion outlet of the apparatus,
wherein each of the first and second ion conduits comprises a respective first end and a respective second end,
wherein the second end of the first ion conduit merges with the first ends of the third and fourth ion conduits, and
wherein the first end of the second ion conduit merges with the second ends of the third and fourth ion conduits.

20. A method for operating a mass spectrometer as recited in claim 1,
wherein the directing of the stream of ions into the first one of the pair of ion storage locations comprises directing the stream of ions into the first one of the pair of ion storage locations through a switchable branched ion guide, and
wherein the directing of the first portion of the stream of ions from the first one of the pair of ion storage locations to the ion cooling cell comprises directing the first portion of the stream of ions to the ion cooling cell through a second switchable branched ion guide.
